(19) United States
(12) Patent Application Publication
(10) Pub. No.: US 2026/0063490 A1
(43) Pub. Date: Mar. 5, 2026

(54) Systems and Methods for Simultaneous Measurement of Static Pressure and Dynamic Pressure Pulsation

(71) Applicant: Saudi Arabian Oil Company, Dhahran (SA)

(72) Inventors: Doru Catalin Turcan, Dhahran (SA); Saad Hamad Al-Dossary, Dhahran (SA); Keith William Brashler, Dhahran (SA); Rehan Farooqi, Dhahran (SA); Ali Alshehri, Thuwal (SA)

(21) Appl. No.: 18/819,271

(22) Filed: Aug. 29, 2024

(51) Int. Cl. G01L 9/00

(52) U.S. Cl. CPC G01L 9/007

(57) ABSTRACT

This disclosure describes an apparatus that includes a housing configured to be attached to an external equipment; a pressure valve configured to pressurize an enclosure within the housing when attached to the external equipment; a proximity probe disposed within the housing such that at least a tip of the proximity probe is within the enclosure; a moveable component disposed within the enclosure opposite to the tip of the proximity probe; and a target placed on the moveable component opposite to the tip of the proximity probe.

### TECHNICAL FIELD

The present disclosure relates to computer-implemented methods and systems for simultaneous measurement of static pressure and dynamic pressure pulsation.

### BACKGROUND

The oil and gas industry uses pipelines to transport hydrocarbons from oil fields to oil and gas processing facilities, refineries, and distribution and shipping terminals. Pipelines are often buried underground and can span significant lengths. Sometimes they can be 1,000 km in length in total with intermediate pump/compressor stations at typical 50-100 km sections, but it is not uncommon to be less than or greater than these lengths. Some sections of the pipelines are underground and some sections are above ground.

Measuring pressure in pipelines is important for ensuring operational safety, efficiency, and regulatory compliance. Accurate pressure monitoring helps prevent leaks and pipeline bursts, which can lead to catastrophic environmental and safety hazards. It ensures optimal flow management and the efficient operation of pumps and compressors. Measuring pressure protects pipeline integrity and equipment, extending their lifespan and minimizing maintenance costs. Additionally, pressure measurement facilitates early detection of leaks and other issues that arise during the lifetime of a pipeline.

Additionally, improving industrial equipment reliability and reducing operating costs, including energy savings, is important for industrial facilities. In state-of-the-art facilities, critical rotating equipment is equipped with advanced machinery protection systems and condition monitoring software. However, these systems sometimes fail to detect critical developing conditions, which can lead to production-related issues, thereby negatively impacting costs and energy savings.

### SUMMARY

In existing industrial facilities, pressure pulsation and static pressure are rarely measured together as they require two different sensors installed in the same location. This arrangement is not practical, and therefore, it is rare that both measurements are provided in existing systems.

This disclosure provides systems and methods that provide pressure pulsation and static pressure measurements using a single installation. The disclosed systems and methods use the measurements to prevent adverse operating conditions that can result in production loss, high maintenance costs, and safety incidents.

One aspect of the subject matter described in this specification may be embodied in an apparatus that includes a housing configured to be attached to an external equipment; a pressure valve configured to pressurize an enclosure within the housing when attached to the external equipment; a proximity probe disposed within the housing such that at least a tip of the proximity probe is within the enclosure; a moveable component disposed within the enclosure opposite to the tip of the proximity probe; and a target placed on the moveable component opposite to the tip of the proximity probe.

The apparatus may each optionally include one or more of the following features.

In some implementations, the moveable component is a piston or a membrane.

In some implementations, the moveable component contacts medium flowing through the external equipment when the housing is attached to the external equipment.

In some implementations, the medium is a fluid or a gas.

In some implementations, the proximity probe is configured to measure a distance between the tip of the proximity probe and the target.

In some implementations, the apparatus further includes a controller configured to perform operations including: receiving direct current (DC) and alternating current (AC) measurements from the proximity probe, wherein the DC and AC measurements are indicative of static and dynamic positions of the target, respectively; and converting the DC and AC measurements to static pressure and dynamic pressure pulsation measurements of a medium flowing through the external equipment.

In some implementations, the operations further include detecting, based on at least one of the static pressure measurement or the dynamic pressure pulsation measurement, a potential malfunction in the equipment.

Another aspect of the subject matter described in this specification may be embodied in a method that involves receiving direct current (DC) and alternating current (AC) measurements from a proximity probe of a pressure measurement device attached to an industrial equipment, wherein a gas or fluid medium flows through the industrial equipment; and converting the DC and AC measurements to static pressure and dynamic pressure pulsation measurements of the medium flowing through the industrial equipment.

The previously described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, the method further involves detecting, based on at least one of the static pressure measurement or the dynamic pressure pulsation measurement, a potential malfunction in the industrial equipment.

In some implementations, detecting, based on at least one of the static pressure measurement or the dynamic pressure pulsation measurement, the potential malfunction in the industrial equipment involves: determining that the static pressure measurement exceeds a predetermined threshold; or determining that the dynamic pressure pulsation measurement changes at least a threshold number of times during a specified period of time.

In some implementations, the pressure measurement device includes: a housing configured to be attached to the industrial equipment; a pressure valve configured to pressurize an enclosure within the housing when attached to the industrial equipment, wherein the proximity probe is disposed within the housing such that at least a tip of the proximity probe is within the enclosure; a moveable component disposed within the enclosure opposite to the tip of the proximity probe; and a target placed on the moveable component opposite to the tip of the proximity probe.

In some implementations, the proximity probe is configured to measure a distance between the tip of the proximity probe and the target.

In some implementations, the moveable component is a piston or a membrane.

In some implementations, the moveable component contacts the gas or fluid medium.

The details of one or more embodiments of these systems and methods are set forth in the accompanying drawings and description below. Other features, objects, and advantages of these systems and methods will be apparent from the description, drawings, and claims.

### BRIEF DESCRIPTION OF DRAWINGS

FIG. 1 illustrates an example pressure measurement device.

FIG. 2 illustrates an example of a neural network.

FIG. 3 illustrates another example pressure measurement device.

FIG. 4 illustrates an example method.

FIG. 5 illustrates a block diagram of an example computer system that can be used to provide computational functionalities associated with described algorithms, methods, functions, processes, flows, and procedures, according to some implementations of the present disclosure.

Like reference numbers and designations in the various drawings indicate like elements.

### DETAILED DESCRIPTION

This disclosure describes a pressure measurement device for simultaneously measuring static pressure and dynamic pressure pulsation in a pipeline. The simultaneous measurement enables the pressure measurement device to provide complete information about the pressure in the pipeline at a measurement point. A dynamic data logger, e.g., a dynamic vibration data collector, can collect the output signal from the pressure measurement device. The readings can be used to perform hydraulic analysis and, in conjunction with other monitoring parameters, can be used for rotating equipment troubleshooting and advanced monitoring of pump pressure.

One of the components of the pressure measurement device is the proximity probe, which is a non-contacting probe that translates the distance between its tip and the target area into voltage. This type of sensor can provide static (VDC) and dynamic measurements (VAC). As described below, these voltages correspond to static pressure and dynamic pressure pulsation, respectively. The media for which the pressure will be monitored is in direct contact with the sensor's target. Therefore, any pressure variation will induce a (proportional) movement of the target. The provided pressure signals can be integrated in machinery protection systems and condition monitoring systems (online and offline).

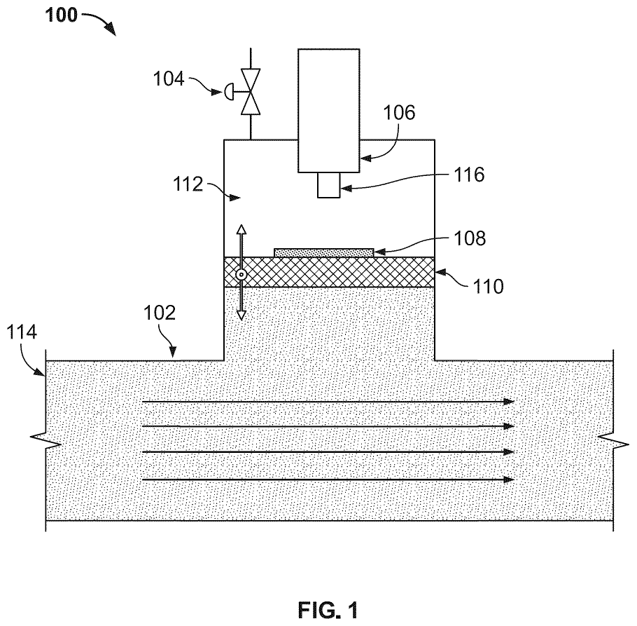

FIG. 1 illustrates an example pressure measurement device 100, according to some implementations. The pressure measurement device 100 can be installed in equipment in which pressure can be measured, e.g., pipelines, storage tanks, separators, etc. In the example of FIG. 1, the pressure measurement device 100 is installed in a pipeline 102. The area in which the pressure measurement device 100 is installed is referred to as a measurement point. A single equipment may include more than one measurement point with more than one corresponding pressure measurement devices. For example, pressure measurement devices can be installed at regular intervals along a pipeline.

As shown in FIG. 1, the pressure measurement device 100 includes a pressure valve 104, a proximity probe 106, a target 108, and a piston 110. The pressure valve 104 is used to create a pressurized enclosure 112 in the body of the device 100, e.g., between the proximity probe 106 and the piston 110. Because the piston 110 is placed in the pressurized enclosure, the piston 110 moves due to the force exerted by media 114 acting on its surface area. For example, the pressure of the media 114 in the pipeline 102 is applied from below, and the piston 110 moves upward. As explained in more detail below, the target 108 is placed on the piston 110. Because the piston 110 moves based on the pressure of the media 114, the distance between the proximity probe 106 and the target 108 changes based on the pressure of the media 114. The proximity probe 106, which measures the distance to the target 108, can therefore measure the pressure of the media 114.

In some implementations, the proximity probe 106 is a probe that complies with the American Petroleum Institute's standard 670 (API 670). The proximity probe 106 (also called an eddy current probe) is a non-contacting transducer used to measure the distance between a probe tip 116 and the surface of the target 108. The proximity probe 106 operates based on the principle of eddy current displacement measurement, generating an electromagnetic field that induces eddy currents in the target 108. The strength of these eddy currents changes with the distance between the probe and the target 108, allowing the measurement of displacement. The output of the proximity probe 106 is expressed in millivolts per mil (mV/mil), where mil is 0.001 inch, indicating the change in output voltage per unit change in distance.

In some implementations, the proximity probe 106 is configured to measure both direct current (DC) signals and alternating current (AC) signals. For DC signals, the proximity probe 106 measures static or slowly changing displacements. The output voltage is directly proportional to the distance between the proximity probe 106 and the target 108. In contrast, to measure AC signals, the proximity probe 106 detects dynamic movements or vibrations of the target 108. For AC measurements, the fluctuating signal is demodulated to separate the AC component from the DC component, allowing for the analysis of the dynamic behavior of the target 108. The DC component represents the average distance or static position of the target 108, while the AC component provides information on the dynamic position of the target 108.

In some implementations, the DC signals and the AC signals are indicative of static pressure and dynamic pressure pulsation, respectively, of media 114 in the pipeline 102. The static pressure in the pipeline 102 determines the static position of the piston 110, and by extension, the static position of the target 108. And as explained, the DC signal measures the static position of the target 108. Therefore, the DC signal is also indicative of the static pressure in the pipeline 102. Similarly, the dynamic pressure in the pipeline 102 determines the dynamic position of the piston 110, and by extension, the dynamic position of the target 108. And as explained, the AC signal measures the dynamic position of the target 108. Therefore, the AC signal is also indicative of the dynamic pressure in the pipeline 102. In some examples, the output of the proximity probe 106 is provided in mV/psi (millivolts/pounds per square inch) by converting the mV/mil as per the relation between the piston 110 motion and the measured pressure. The pressure measurement device 100 can be calibrated for this measurement before or after installation.

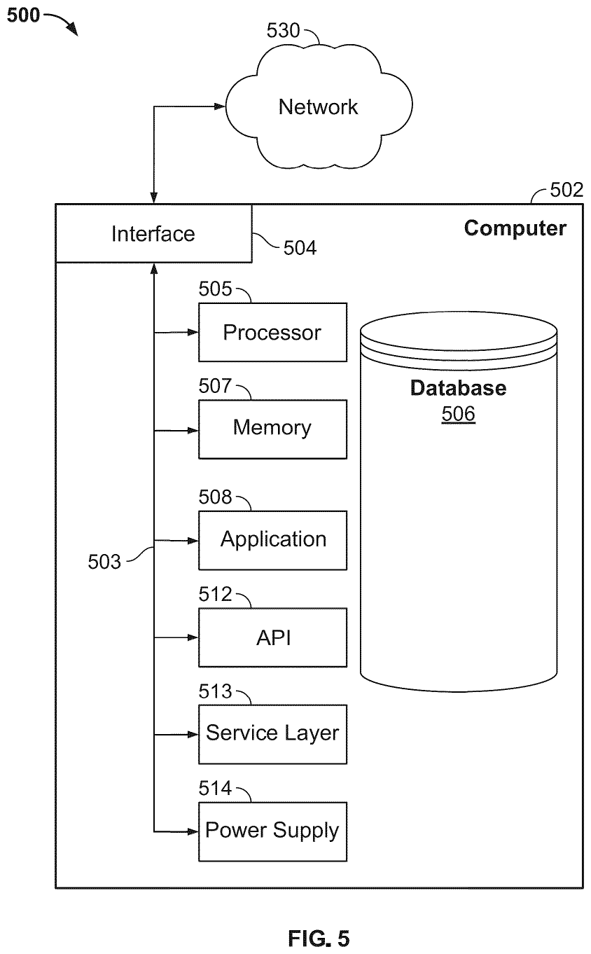

In some implementations, the pressure measurement device 100 uses the proximity probe 106 to simultaneously measure the static pressure and dynamic pressure pulsation. By doing so, the pressure measurement device 100 obtains complete information about the existing pressure in the pipeline 102. More specifically, the proximity probe 106 can provide the measurements to a computing system on the pressure measurement device 100 itself or a remote computing system (perhaps via a wired or wireless connection). In some examples, the computing system can include one or more of the components of the computer system 500 described in FIG. 5.

In some implementations, the computing system can use the measurements to detect abnormal operation and/or system malfunctions. More specifically, excessive pressure pulsation is indicative of a process disruption, perhaps due to abnormal operation and/or system malfunctions, which can lead to failures of other equipment in the facility. In some examples, the excessive pressure pulsation can be characterized as the AC signal being greater than a predetermined threshold for a specified period of time. In other examples, the excessive pressure pulsation can be characterized as the AC signal changing at least a threshold number of times during a specified period of time. Similarly, the static pressure abnormal increase or decrease can also indicate abnormal operation and/or system malfunctions. In some examples, the excessive static pressure can be characterized as the DC signal exceeding a predetermined threshold.

In some implementations, the pressure measurement device 100 is used for enhanced rotating equipment monitoring and troubleshooting. In these implementations, the complete pressure information facilitates determining a functional condition for many industrial systems. In addition to other primary monitoring parameters (e.g., vibration, temperature, etc.), the complete pressure information increases the troubleshooting and diagnostic capabilities and accuracy for pumps, compressors, and other equipment in industrial systems. As an example, the pressure measurement device 100 can be used for monitoring rotating equipment's associated pipelines. More specifically, the pressure measurement device 100 provides complete information about the media pressure inside the pipeline, which is one of the main parameters used to monitor the pipelines'capabilities to operate safely. As another example, the pressure measurement device 100 can be used for differential pressure measurements. In this example, the “pressurized enclosure” part of the pressure measurement device 100 can be connected to a “reference pressure,” which enables measurement of differential pressure in equipment. For instance, placing the pressure measurement device 100 at an inlet and outlet of a pump or a turbine can provide relative differential static as well as dynamic pressure values.

In some implementations, a computer system is configured to receive the measurements of the pressure measurement device 100. The computer system can use the measurements to train a machine learning (ML) model for diagnostic and prognostic functions. More specifically, the ML model is trained to examine different combinations of variables, including, but not limited to, main pump operating parameters (e.g., head and rated flow), liquid level in the tank(s), environmental temperature, service temperature, service density, and valves'positions. The ML model is trained to identify combinations of variables that are indicative of component faults. Further, the ML model is trained to correlate the voltage data from the pressure measurement device 100 to the combinations of variables that are indicative of component faults. More specifically, the voltage time fluctuation pattern (amplitude, rate of change, etc.) can be used to train the ML model to identify specific conditions that can lead to failures. Accordingly, the ML model can be used to identify and classify component failures based on voltage data from the pressure measurement device 100. The failures that the pressure measurement device 100 can detect include, but are not limited to, a worn-out, cracked, unbalanced, and/or eccentric centrifugal impeller; leaking pipes; worn-out pistons and/or defective valves in reciprocating machines; passing valves; and a hydraulic machine operating outside its preferred range.

In some implementations, the ML model of the workflow can be implemented by an artificial neural network (ANN), which is a computational model that includes a collection of layers of nodes interconnected by edges with weights and activation functions associated with the nodes. Input data is applied to one or more input nodes of the ANN and propagate through the ANN in a manner influenced by the weights and activation functions of the nodes, e.g., the output of a node is related to the application of the activation function to the weighted sum of its inputs. As a result, one or more outputs are obtained at corresponding output node(s) of the ANN. The layer(s) of nodes between the input nodes and the output node(s) are referred to as hidden layers, and each successive layer takes the output of the previous layer as input. Parameters of the ANN, including the weights associated with the nodes of the ANN, are learnt during a training phase (or training).

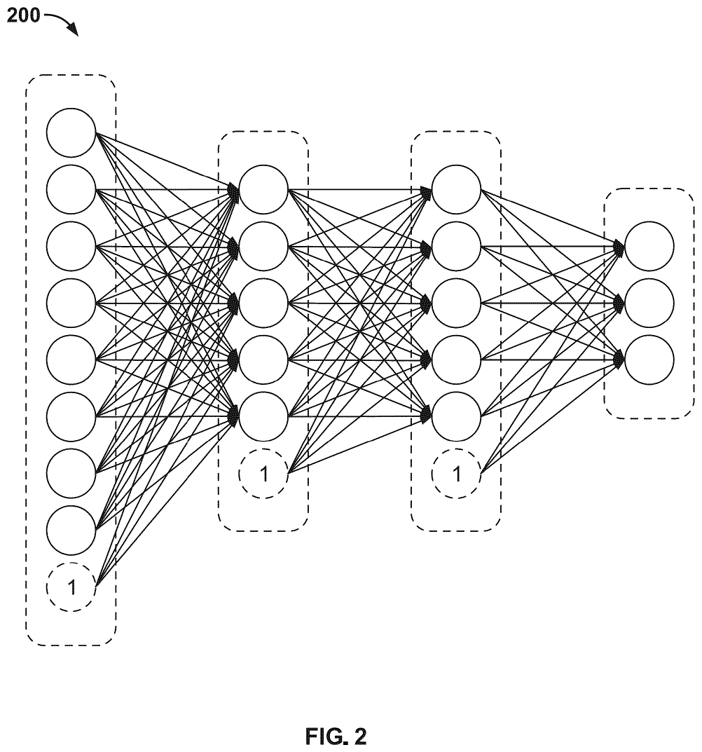

FIG. 2 illustrates an example of a neural network. At a high level, a neural network 200 may be graphically depicted as comprising nodes, where here any circle represents a node, and edges, shown here as directed lines. The nodes may be grouped to form layers. FIG. 2 displays four layers of nodes where the nodes are grouped into columns, however, other groupings are also possible. The edges connect the nodes. Edges may connect, or not connect, to any node(s) regardless of which layer the node(s) is in. That is, the nodes may be sparsely and residually connected. A neural network 200 will have at least two layers, where the first layer is considered the “input layer” and the last layer is the “output layer. ” Any intermediate layer is usually described as a “hidden layer”. A neural network may have zero or more hidden layers, and a neural network 200 with at least one hidden layer may be described as a “deep” neural network or as a “deep learning model. ” In general, a neural network 200 may have more than one node in the output layer. In this case the neural network 200 may be referred to as a “multi-target” or “multi-output” network.

Nodes and edges carry additional associations. Namely, every edge is associated with a numerical value. The edge numerical values, or even the edges themselves, are often referred to as “weights” or “parameters”. While training a neural network 200, numerical values are assigned to each edge. Additionally, every node is associated with a numerical variable and an activation function. Every node in a neural network 200 may have a different associated activation function. Often, as a shorthand, activation functions are described by the function ƒ by which it is composed. That is, an activation function composed of a linear function ƒ may simply be referred to as a linear activation function without undue ambiguity.

When the neural network 200 receives an input, the input is propagated through the network according to the activation functions and incoming node values and edge values to compute a value for each node. That is, the numerical value for each node may change for each received input. Occasionally, nodes are assigned fixed numerical values, such as the value of 1, that are not affected by the input or altered according to edge values and activation functions. Fixed nodes are often referred to as “biases” or “bias nodes”, displayed in FIG. 2 with a dashed circle.

In some implementations, the neural network 200 may contain specialized layers, such as a normalization layer, or additional connection procedures, like concatenation. One skilled in the art will appreciate that these alterations do not exceed the scope of this disclosure.

As noted, the training procedure for the neural network 200 comprises assigning values to the edges. To begin training, the edges are assigned initial values. These values may be assigned randomly, assigned according to a prescribed distribution, assigned manually, or by some other assignment mechanism. Once edge values have been initialized, the neural network 200 may act as a function, such that it may receive inputs and produce an output. As such, at least one input is propagated through the neural network 200 to produce an output. Recall that a given dataset will be composed of inputs and associated target(s), where the target(s) represent the “ground truth”, or the otherwise desired output. The neural network 200 output is compared to the associated input data target(s). The comparison of the neural network 200 output to the target(s) is typically performed by a so-called “loss function”; although other names for this comparison function such as “error function” and “cost function” are commonly employed. Many types of loss functions are available, such as the mean-squared-error function. However, the general characteristic of a loss function is that it provides a numerical evaluation of the similarity between the neural network 200 output and the associated target(s). The loss function may also be constructed to impose additional constraints on the values assumed by the edges, for example, by adding a penalty term, which may be physics-based, or a regularization term. Generally, the goal of a training procedure is to alter the edge values to promote similarity between the neural network 200 output and associated target(s) over the dataset. Thus, the loss function is used to guide changes made to the edge values, typically through a process called “backpropagation.”

One popular form of neural network is the convolutional neural network (CNN). The CNN assumes some kind of translational invariance in the features of the dataset being analyzed, i.e., the relationships between a node in a layer and its parent/children nodes is independent of where within a particular layer that node is. Those skilled in the art will appreciate that the ML model may be implemented as any suitable neural network, such as but not limited to a Feed Forward Neural Network, a Convolutional Neural Network, a Radial Basis Functional Neural Network, a Recurrent Neural Network, LSTM—Long Short-Term Memory, etc. Further, the ISM and OSM may be the same type of neural network, or different types of neural networks.

While multiple embodiments using different machine-learned models have been suggested, one skilled in the art will appreciate that this process, of using an ML model for component failure identification and classification, is not limited to the listed machine-learned models. Machine-learned models such as a random forest, support vector machines, or non-parametric methods such as K-nearest neighbors may be readily inserted into this framework and do not depart from the scope of this disclosure. Further distinctions may be made among neural networks.

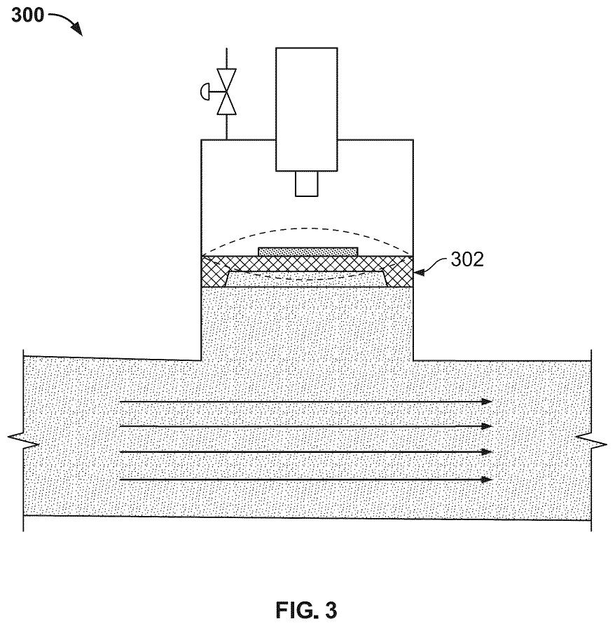

FIG. 3 illustrates another example pressure measurement device 300. The pressure measurement device 300 replaces the piston of the pressure measurement device 100 with a membrane 302. The membrane 302 can be made from a polymer, e.g., a polyimide.

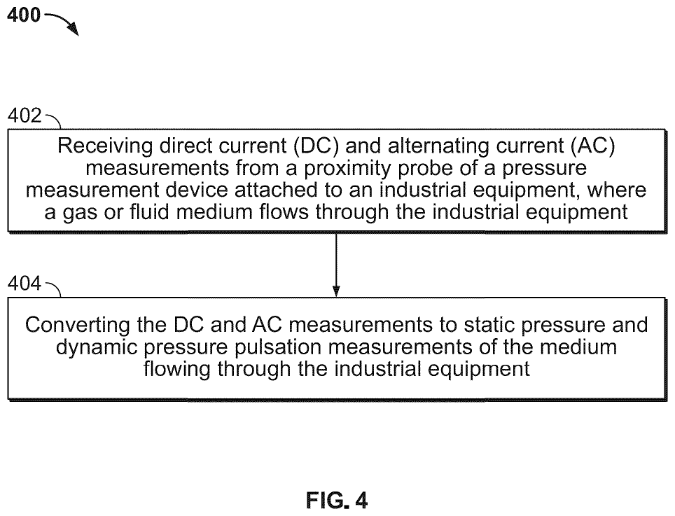

FIG. 4 illustrates an example method 400. For convenience, method 400 will be described as being performed by a computer system having one or more computers located in one or more locations and programmed appropriately in accordance with this specification. An example of the computer system is the computing system 500 illustrated in FIG. 5 and described below.

At 402, method 400 involves receiving direct current (DC) and alternating current (AC) measurements from a proximity probe of a pressure measurement device attached to an industrial equipment, where a gas or fluid medium flows through the industrial equipment.

At 404, method 400 involves converting the DC and AC measurements to static pressure and dynamic pressure pulsation measurements of the medium flowing through the industrial equipment.

In some implementations, the method further involves detecting, based on at least one of the static pressure measurement or the dynamic pressure pulsation measurement, a potential malfunction in the industrial equipment.

In some implementations, detecting, based on at least one of the static pressure measurement or the dynamic pressure pulsation measurement, the potential malfunction in the industrial equipment involves: determining that the static pressure measurement exceeds a predetermined threshold; or determining that the dynamic pressure pulsation measurement changes at least a threshold number of times during a specified period of time.

In some implementations, the pressure measurement device includes: a housing configured to be attached to the industrial equipment; a pressure valve configured to pressurize an enclosure within the housing when attached to the industrial equipment, wherein the proximity probe is disposed within the housing such that at least a tip of the proximity probe is within the enclosure; a moveable component disposed within the enclosure opposite to the tip of the proximity probe; and a target placed on the moveable component opposite to the tip of the proximity probe.

In some implementations, the proximity probe is configured to measure a distance between the tip of the proximity probe and the target.

In some implementations, the moveable component is a piston or a membrane.

In some implementations, the moveable component contacts the gas or fluid medium.

FIG. 5 is a block diagram of an example computer system 500 that can be used to provide computational functionalities associated with described algorithms, methods, functions, processes, flows, and procedures, according to some implementations of the present disclosure. In some implementations, the computer system performing process 400 can be the computer system 500, include the computer system 500, or the computer system performing process 400 can communicate with the computer system 500.

The illustrated computer 502 is intended to encompass any computing device such as a server, a desktop computer, an embedded computer, a laptop/notebook computer, a wireless data port, a smart phone, a personal data assistant (PDA), a tablet computing device, or one or more processors within these devices, including physical instances, virtual instances, or both. The computer 502 can include input devices such as keypads, keyboards, and touch screens that can accept user information. Also, the computer 502 can include output devices that can convey information associated with the operation of the computer 502. The information can include digital data, visual data, audio information, or a combination of information. The information can be presented in a graphical user interface (UI) (or GUI). In some implementations, the inputs and outputs include display ports (such as DVI-I+2× display ports), USB 3.0, GbE ports, isolated DI/O, SATA-III (6.0 Gb/s) ports, mPCIe slots, a combination of these, or other ports. In instances of an edge gateway, the computer 502 can include a Smart Embedded Management Agent (SEMA), such as a built-in ADLINK SEMA 2.2, and a video sync technology, such as Quick Sync Video technology supported by ADLINK MSDK+. In some examples, the computer 502 can include the MXE-5400 Series processor-based fanless embedded computer by ADLINK, though the computer 502 can take other forms or include other components.

The computer 502 can serve in a role as a client, a network component, a server, a database, a persistency, or components of a computer system for performing the subject matter described in the present disclosure. The illustrated computer 502 is communicably coupled with a network 530. In some implementations, one or more components of the computer 502 can be configured to operate within different environments, including cloud-computing-based environments, local environments, global environments, and combinations of environments.

At a high level, the computer 502 is an electronic computing device operable to receive, transmit, process, store, and manage data and information associated with the described subject matter. According to some implementations, the computer 502 can also include, or be communicably coupled with, an application server, an email server, a web server, a caching server, a streaming data server, or a combination of servers.

The computer 502 can receive requests over network 530 from a client application (for example, executing on another computer 502). The computer 502 can respond to the received requests by processing the received requests using software applications. Requests can also be sent to the computer 502 from internal users (for example, from a command console), external (or third) parties, automated applications, entities, individuals, systems, and computers.

Each of the components of the computer 502 can communicate using a system bus 503. In some implementations, any or all of the components of the computer 502, including hardware or software components, can interface with each other or the interface 504 (or a combination of both), over the system bus. Interfaces can use an application programming interface (API) 512, a service layer 513, or a combination of the API 512 and service layer 513. The API 512 can include specifications for routines, data structures, and object classes. The API 512 can be either computer-language independent or dependent. The API 512 can refer to a complete interface, a single function, or a set of APIs 512.

The service layer 513 can provide software services to the computer 502 and other components (whether illustrated or not) that are communicably coupled to the computer 502. The functionality of the computer 502 can be accessible for all service consumers using this service layer 513. Software services, such as those provided by the service layer 513, can provide reusable, defined functionalities through a defined interface. For example, the interface can be software written in JAVA, C++, or a language providing data in extensible markup language (XML) format. While illustrated as an integrated component of the computer 502, in alternative implementations, the API 512 or the service layer 513 can be stand-alone components in relation to other components of the computer 502 and other components communicably coupled to the computer 502. Moreover, any or all parts of the API 512 or the service layer 513 can be implemented as child or sub-modules of another software module, enterprise application, or hardware module without departing from the scope of the present disclosure.

The computer 502 can include an interface 504. Although illustrated as a single interface 504 in FIG. 5, two or more interfaces 504 can be used according to particular needs, desires, or particular implementations of the computer 502 and the described functionality. The interface 504 can be used by the computer 502 for communicating with other systems that are connected to the network 530 (whether illustrated or not) in a distributed environment. Generally, the interface 504 can include, or be implemented using, logic encoded in software or hardware (or a combination of software and hardware) operable to communicate with the network 530. More specifically, the interface 504 can include software supporting one or more communication protocols associated with communications. As such, the network 530 or the interface's hardware can be operable to communicate physical signals within and outside of the illustrated computer 502.

The computer 502 includes a processor 505. Although illustrated as a single processor 505 in FIG. 5, two or more processors 505 can be used according to particular needs, desires, or particular implementations of the computer 502 and the described functionality. Generally, the processor 505 can execute instructions and manipulate data to perform the operations of the computer 502, including operations using algorithms, methods, functions, processes, flows, and procedures as described in the present disclosure.

The computer 502 can also include a database 506 that can hold data for the computer 502 and other components connected to the network 530 (whether illustrated or not). For example, database 506 can be an in-memory, conventional, or a database storing data consistent with the present disclosure. In some implementations, the database 506 can be a combination of two or more different database types (for example, hybrid in-memory and conventional databases) according to particular needs, desires, or particular implementations of the computer 502 and the described functionality. Although illustrated as a single database 506 in FIG. 5, two or more databases (of the same, different, or combination of types) can be used according to particular needs, desires, or particular implementations of the computer 502 and the described functionality. While database 506 is illustrated as an internal component of the computer 502, in alternative implementations, database 506 can be external to the computer 502.

The computer 502 also includes a memory 507 that can hold data for the computer 502 or a combination of components connected to the network 530 (whether illustrated or not). Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 5, two or more memories 507 (of the same, different, or combination of types) can be used according to particular needs, desires, or particular implementations of the computer 502 and the described functionality. While memory 507 is illustrated as an internal component of the computer 502, in alternative implementations, memory 507 can be external to the computer 502.

An application 508 can be an algorithmic software engine providing functionality according to particular needs, desires, or particular implementations of the computer 502 and the described functionality. For example, an application 508 can serve as one or more components, modules, or applications 508. Multiple applications 508 can be implemented on the computer 502. Each application 508 can be internal or external to the computer 502.

The computer 502 can also include a power supply 514. The power supply 514 can include a rechargeable or non-rechargeable battery that can be configured to be either user-or non-user-replaceable. In some implementations, the power supply 514 can include power-conversion and management circuits, including recharging, standby, and power management functionalities. In some implementations, the power-supply 514 can include a power plug to allow the computer 502 to be plugged into a wall socket or a power source to, for example, power the computer 502 or recharge a rechargeable battery.

There can be any number of computers 502 associated with, or external to, a computer system including computer 502, with each computer 502 communicating over network 530. Further, the terms “client”, “user”, and other appropriate terminology can be used interchangeably without departing from the scope of the present disclosure. Moreover, the present disclosure contemplates that many users can use one computer 502 and one user can use multiple computers 502.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, or in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations; and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

We claim:

1. An apparatus comprising:
a housing configured to be attached to an external equipment;
a pressure valve configured to pressurize an enclosure within the housing when attached to the external equipment;
a proximity probe disposed within the housing such that at least a tip of the proximity probe is within the enclosure;
a moveable component disposed within the enclosure opposite to the tip of the proximity probe; and
a target placed on the moveable component opposite to the tip of the proximity probe.

2. The apparatus of claim 1, wherein the moveable component is a piston or a membrane.

3. The apparatus of claim 1, wherein the moveable component contacts medium flowing through the external equipment when the housing is attached to the external equipment.

4. The apparatus of claim 3, wherein the medium is a fluid or a gas.

5. The apparatus of claim 1, wherein the proximity probe is configured to measure a distance between the tip of the proximity probe and the target.

6. The apparatus of claim 1, further comprising:
a controller configured to perform operations comprising:
receiving direct current (DC) and alternating current (AC) measurements from the proximity probe, wherein the DC and AC measurements are indicative of static and dynamic positions of the target, respectively; and
converting the DC and AC measurements to static pressure and dynamic pressure pulsation measurements of a medium flowing through the external equipment.

7. The apparatus of claim 6, the operations further comprising:
detecting, based on at least one of the static pressure measurement or the dynamic pressure pulsation measurement, a potential malfunction in the equipment.

8. A method comprising:
receiving direct current (DC) and alternating current (AC) measurements from a proximity probe of a pressure measurement device attached to an industrial equipment, wherein a gas or fluid medium flows through the industrial equipment; and
converting the DC and AC measurements to static pressure and dynamic pressure pulsation measurements of the medium flowing through the industrial equipment.

9. The method of claim 8, further comprising:
detecting, based on at least one of the static pressure measurement or the dynamic pressure pulsation measurement, a potential malfunction in the industrial equipment.

10. The method of claim 9, wherein detecting, based on at least one of the static pressure measurement or the dynamic pressure pulsation measurement, the potential malfunction in the industrial equipment comprises:
determining that the static pressure measurement exceeds a predetermined threshold; or
determining that the dynamic pressure pulsation measurement changes at least a threshold number of times during a specified period of time.

11. The method of claim 8, wherein the pressure measurement device comprises:
a housing configured to be attached to the industrial equipment;
a pressure valve configured to pressurize an enclosure within the housing when attached to the industrial equipment, wherein the proximity probe is disposed within the housing such that at least a tip of the proximity probe is within the enclosure;
a moveable component disposed within the enclosure opposite to the tip of the proximity probe; and
a target placed on the moveable component opposite to the tip of the proximity probe.

12. The method of claim 11, wherein the proximity probe is configured to measure a distance between the tip of the proximity probe and the target.

13. The method of claim 11, wherein the moveable component is a piston or a membrane.

14. The method of claim 11, wherein the moveable component contacts the gas or fluid medium.

15. A system comprising:
a housing configured to be attached to an external equipment;
a pressure valve configured to pressurize an enclosure within the housing when attached to the external equipment;
a proximity probe disposed within the housing such that at least a tip of the proximity probe is within the enclosure;
a moveable component disposed within the enclosure opposite to the tip of the proximity probe;
a target placed on the moveable component opposite to the tip of the proximity probe; and
one or more processors configured to perform operations comprising:
receiving direct current (DC) and alternating current (AC) measurements from the proximity probe, wherein a gas or fluid medium flows through the external equipment; and
converting the DC and AC measurements to static pressure and dynamic pressure pulsation measurements of the medium flowing through the external equipment.

16. The system of claim 15, further comprising:
detecting, based on at least one of the static pressure measurement or the dynamic pressure pulsation measurement, a potential malfunction in the external equipment.

17. The method of claim 16, wherein detecting, based on at least one of the static pressure measurement or the dynamic pressure pulsation measurement, the potential malfunction in the external equipment comprises:
determining that the static pressure measurement exceeds a predetermined threshold; or
determining that the dynamic pressure pulsation measurement changes at least a threshold number of times during a specified period of time.

18. The system of claim 15, wherein the moveable component is a piston or a membrane.

19. The system of claim 15, wherein the proximity probe is configured to measure a distance between the tip of the proximity probe and the target.
